(19) United States
(12) Patent Application Publication
(10) Pub. No.: US 2002/0092016 A1
(43) Pub. Date: Jul. 11, 2002

(54) Method for monitoring access to a restricted-access system, and a restricted-access system

(76) Inventor: Gero Offer, Gilching (DE)

Correspondence Address: BELL, BOYD & LLOYD, LLC, P. O. BOX 1135, CHICAGO, IL, 60690-1135, US

(21) Appl. No.: 10/005,657

(22) Filed: Nov. 7, 2001

(30) Foreign Application Priority Data
Nov. 8, 2000 (DE) 100 55 237.4

(51) Int. Cl. H04N 7/16; H04N 7/173

(52) U.S. Cl. 725/25; 725/104; 725/98

(57) ABSTRACT

A method and restricted-access system for monitoring access to a restricted-access system including the setting up of a second telecommunications connection, via which an identifier for a control device is sent to a transmission provider which, in response to this, sends a decoding key via the second telecommunications connection to the user of the control device, wherein the user then enters the transmitted decoding key into the control device.

### BACKGROUND OF THE INVENTION

Restricted-access systems are known, for example, in the form of pay-TV systems, in which pay television programs are received by the user only once an appropriate fee has been paid. Access to the pay-TV system is thus restricted to that user group which, for example, has set up a credit account (prepaid account) with the service provider who is offering the television programs. A wide range of different types of identification measures are known in order to allow reception of television channels, which transmit such television programs, only by a user group for whom access is authorized. In this case, it must always be remembered that, in the television transmission field, the television picture is transmitted from one end, namely from the television transmitter to the television receiver, such as a domestic television set, without any form of back-channel.

Measures such as these are, for example, the setting up of specific decoders, also referred to as set-top boxes, which allow an encrypted TV signal to be received and to be decrypted.

A large number of access authorization or monitoring systems for encryption and decryption systems for transmitting digital or analogue TV programs are also known. The decrypting key is normally stored on a card, also referred to as a smart card, which the potential user must buy and push into a control device (set-top box) in order to use it. Such set-top boxes are costly and complicated to produce, and are thus associated with considerable hardware costs, owing to the complex asymmetric coding, which is based on security measures, of the television signals and the decryption (which is required for this purpose) via the control devices with the aid of a key on a smart card.

In consequence, the present invention is directed toward providing a method for monitoring access to a restricted-access system, such as a pay-TV system, and of providing a corresponding restricted-access system, which allows access to pay-per-view television programs in a simple and low-cost manner, without incurring high production costs.

### SUMMARY OF THE INVENTION

A major aspect of the present invention is that a second telecommunications connection is set up (for example, via a mobile telephone) from the user to the service provider who provides the television programs. This second telecommunications connection is used to pass on an identifier from the control device, which the user intends to use, and various further information relating to individual user requests to the service provider, who then sends back a decoding key via the existing second telecommunications connection to the user's mobile telephone. The user can then enter the decoding key which he/she has read via an input device into the control device, and a processor device within the control device then uses a decoding algorithm to link the decoding key and the identification number of the control device to one another, and hence to calculate decoding information. This decoding information is applied directly by the control device to the television channel, at which point the latter is enabled with the desired television program. This advantageously results in the situation in which the control device does not need any complex decryption process for decrypting the encrypted television channel data, thus obviating a major proportion of the production costs for such a control device.

The process of setting up a second telecommunications connection via a mobile telephone even makes it possible for a type of back-channel to be set up to the transmission provider, thus allowing two-way communication between the user and the transmission provider. This communication may take place, for example, via a short message service message (SMS message), a Wireless Access Protocol (WAP) and/or by voice and tone dialing. It is thus possible to carry out a certain checking process between the transmission provider and the user, and the user need only respond to the questions asked of him/her by entering the appropriate responses in his/her mobile telephone.

Advantageously, each control device housing has a unique identification number printed on it as an identifier, which cannot be confused with that of any other control device. In consequence, when the user transmits this identification number to the transmission provider, this allows the decoding key, which is then enabled by the transmission provider, to be used exclusively by a single control device; namely, that control device which has this identification number. The television channel with the associated television program can then be received only via this single control device. There is thus no point in passing on the decoding key to further users with other control devices for the other users.

In one preferred embodiment, a profile can be stored in the transmission provider, also referred to as the pay-TV server, which can also include a specific personal identification number (PIN) in addition to the control device identification number. Thus, not only a control-device-dependent identification number but also a user-dependent identification number can be entered, thus making it possible to carry out access monitoring for a number of users in a restricted-access system. Family members can thus access certain television programs and television channels only when their personal identification number, which is stored in the service provider, allows this, depending on their age.

In a further embodiment, the processor device (chip) which contains the decoding algorithm can be installed in the television set, so that the decoding key, which has been received on the mobile telephone, can be entered in the processor device via a remote control which is suitable for that television set. This allows the decoding key to be entered in a manner which is uncomplicated, quick and convenient.

It is also feasible for this decoding key to be entered via the Bluetooth data transmission technique, by transmitting it directly from the mobile telephone to the control device, without wires, so that the numbers forming the decoding key do not need to be entered once again.

Additional features and advantages of the present invention are described in, and will be apparent from, the following Detailed Description of the Invention and the Figures.

### BRIEF DESCRIPTION OF THE FIGURES

FIG. 1a shows a schematic illustration of a first embodiment of a control device for a restricted-access system in accordance with the teachings of the present invention.

FIG. 1b shows a schematic illustration of a second embodiment of a control device for a restricted-access system.

FIG. 2 shows a schematic illustration of the second telecommunications connection.

FIG. 3 shows a flowchart of the method according to the present invention.

### DETAILED DESCRIPTION OF THE INVENTION

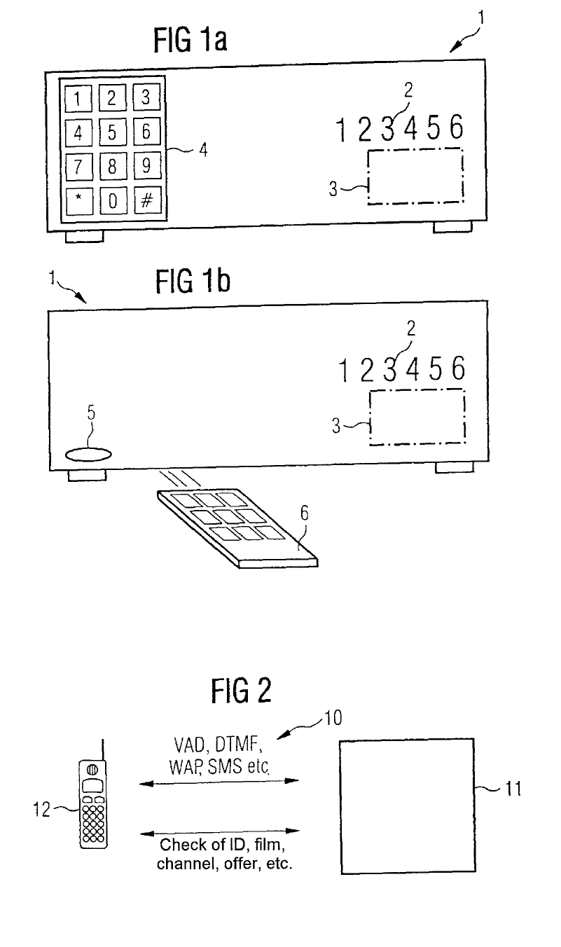

FIG. 1a shows a control device 1 having an identification number 2 printed on its housing, a chip 3 as a processor device and an input device 4 in the form of a keypad. Such a control device 1 is connected between the television set, on which the television program is shown, and an antenna input which receives the television channel with the associated television program. Each control device designed in such a way has its own unique identification number which is normally printed on the housing of the control device.

A complex decoding algorithm is programmed in the processor device 3 and is responsible for linking the identification number of the appliance, which is already programmed in it, and the decoding key, which can be entered via the input device 4, with one another and then for enabling the television channel which is connected to the control device, in order to allow this to be received on the television set. Thus, all that is required is for the decoding code and the identification channel number to be linked to one another by the decoding algorithm, and there is thus no need for any complex decoding of encrypted television signals with the aid of a key on a smart card.

In a further embodiment as shown in FIG. 1b, the input device can be replaced by a remote control 6 for television sets, which communicates with an interface 5 in the control device 1. This makes it possible for the user to enter the decoding key into the control device without needing to have direct contact with the control device. The control device can thus either entirely or partially also be installed in the television set, without needing to carry out any changes whatsoever to the housing of the television set.

A schematic illustration of the setting up of the second telecommunications connection 10 is illustrated, by way of example, in FIG. 2. Such a telecommunications connection 10 can be produced by a mobile telephone 12, which the user has, and the transmission provider 11, and they communicate with one another via a telephone connection. In this case, data which are used to ask the user for the identification number of the control device 1 and his/her program requests, and for television channel requests and offer requests can be transmitted to the mobile telephone by SMS, for example. The user then enters the respective responses in the form of voice or tone dialing (VAD, DTMF), and sends such entered data from his/her mobile telephone to the transmission provider 11 via the second telecommunications connection 10. Such data also can be entered and transmitted via SMS and/or WAP.

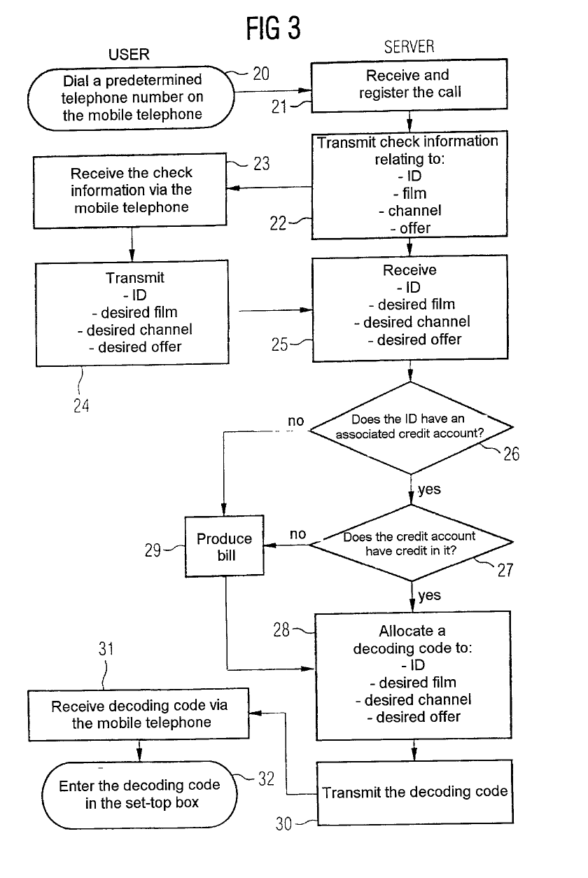

FIG. 3 shows the method according to the present invention for monitoring access to a restricted-access pay-TV system. For this purpose, in step 20, a predetermined telephone number, which the user knows, is first of all dialed on a mobile telephone, thus calling the transmission provider. When the transmission provider receives this call, it is registered (step 21). Then, in the steps 22 to 25 of a checking mode, the user transmits to the transmission provider the identification number 2 and the information about the program which he would like to watch, the desired television channel and the desired program offer or similar information. To do this, in step 22, the transmission provider sends the checking information to the user with the request for him to transmit the identification number of the control device 1, the desired film and/or the desired television channel and/or the desired television program offer. In step 23, the user receives this checking information via the mobile telephone and, in the form of a back-channel, sends the desired information and the identification number to the transmission provider, in step 24. The transmission provider receives the desired data in step 25.

In step 26, the transmission provider now checks whether the transmitted identification number has an associated credit account (prepaid account) via which payment for the desired film can be debited. If such a credit account exists, a check is carried out in step 27 to determine whether this credit account has sufficient credit. If the credit account does not have sufficient credit, then, for example, the user is presented with a bill in step 29. Such billing also takes place if it is found, in step 26, that the identification number has no associated credit account.

However, if the credit account exists and has sufficient credit, then a decoding key is allocated, in step 28, to the corresponding identification number in conjunction with the desired film, the desired channel and/or the desired program offer. The transmission provider then sends this selected decoding key to the user, in step 30, once again by the second telecommunications connection 10. In step 31, the user receives the decoding key via the mobile telephone and, once this decoding key has been received, enters it, in step 32, into the control device (set-top box) 1 via the input device 4, via a remote control or the Bluetooth data transmission technique.

After entering the decoding key, the integrated chip uses its programmed, decoding algorithm to link the identification number and the decoding key with one another, and applies the decoding information obtained in this way to the television channel.

A simple and low-cost control device, therefore, can be produced in large quantities. There is no need for any smart card for decrypting the encrypted television channels, and complex scanning mechanisms for scanning such a smart card are likewise avoided, as are the logic and modem for setting up telecommunications connections between the set-top box and the service provider.

The method features according to the present invention can be used for the restricted-access system according to the present invention to transmit television programs.

Although the present invention has been described with reference to specific embodiments, those of skill in the art will recognize that changes may be made thereto without departing from the spirit and scope of the invention as set forth in the hereafter appended claims.

1. A method for monitoring access to a restricted-access system for transmitting at least one desired television program, the method comprising the steps of:
providing a transmitting device of a service provider for transmitting the at least one desired television program via at least one desired television channel of a first telecommunications connection;
providing at least one control device arranged at a receiving end for controlling access by a user to pay-per-view television programs;
providing at least one television set for receiving the at least one desired television program;
setting up a second telecommunications connection between the user and the service provider using a telecommunications system;
checking an identifier allocated to the control device;
checking additional information about the desired television program, by the service provider, via the second telecommunications connection;
allocating a decoding key to the identifier and to the additional information by the service provider;
transmitting the decoding key from the service provider to the user via the second telecommunications connection;
inputting the decoding key in the control device by the user via an input device;
linking the decoding key and the identifier in the control device to form decoding information; and
enabling the desired television channel with the at least one desired television program to allow the at least one desired television program to be received by the television set via the first telecommunications connection.

2. A method for monitoring access to a restricted-access system for transmitting at least one desired television program as claimed in claim 1, the method further comprising the step of:
setting up the second telecommunications connection by a call from the user to the service provider via a mobile telephone.

3. A method for monitoring access to a restricted-access system for transmitting at least one desired television program as claimed in claim 2, wherein the step of checking further includes entering data via at least one of voice selection, tone selection, a Wireless Access Protocol and a short message service, and transmitting the data.

4. A method for monitoring access to a restricted-access system for transmitting at least one desired television program as claimed in claim 1, wherein the control device is connected between the television set and an antenna device which receives the television programs.

5. A method for monitoring access to a restricted-access system for transmitting at least one desired television program as claimed in claim 1, the method further comprising the step of:
checking a credit account of the user by the service provider once the identifier has been checked.

6. A method for monitoring access to a restricted-access system for transmitting at least one desired television program as claimed in claim 1, the method further comprising the step of:
checking a personal identification number of the user.

7. A restricted-access system for transmitting at least one desired television program, comprising:
a transmitting device of a service provider for transmitting the at least one desired television program via at least one desired television channel of a first telecommunications connection;
at least one control device arranged at a receiving end for controlling access by a user to pay-per-view television programs;
at least one television set for receiving the at least one desired television program;
a second telecommunications connection set up between the user and the service provider via a telecommunications system, wherein the service provider transmits a decoding key to the user, via the second telecommunications connection, in order to check both an identifier which is allocated to the control device and additional information about the desired television program, and in order to allocate the decoding key to the identifier and to the additional information;
an input device for inputting the decoding key into the control device; and
a processor device for linking the input decoding key with the identifier and for enabling the desired television channel with the desired television program to allow the desired television program to be received by the at least one television set via the first telecommunications connection.

8. A restricted-access system for transmitting at least one desired television program as claimed in claim 7, wherein the input device is a television set remote control and the processor device is arranged in the television set.

9. A restricted-access system for transmitting at least one desired television program as claimed in claim 7, wherein a mobile telephone is used by the user for setting up the second telecommunications connection.

10. A restricted-access system for transmitting at least one desired television program as claimed in claim 9, wherein the input device is a receiving device arranged on the control device and uses Bluetooth data transmission technology to receive the decoding key, which is received by the mobile telephone, from a transmitting device in the mobile telephone.
